(19) United States
(12) Patent Application Publication
(10) Pub. No.: US 2013/0232964 A1
(43) Pub. Date: Sep. 12, 2013

(54) HYBRID POWER SYSTEM

(71) Applicants: Shawn James Nielsen, Spruce Grove (CA); Sinisa Dobrijevic, Edmonton (CA)

(72) Inventors: Shawn James Nielsen, Spruce Grove (CA); Sinisa Dobrijevic, Edmonton (CA)

(21) Appl. No.: 13/885,476

(22) PCT Filed: Nov. 15, 2010
(86) PCT No.: PCT/CA2010/001774

§ 371 Date: May 15, 2013

(51) Int. Cl. F15B 15/18

(52) U.S. Cl. CPC F15B 15/18
USPC 60/486

(57) ABSTRACT

A hybrid power source includes an electric power source, a first hydraulic pump powered by the electric power source, a hydrocarbon burning power source, and a second hydraulic pump powered by the hydrocarbon burning power source. A hydraulic fluid output is fed by a combined output from the first hydraulic pump and the second hydraulic pump. A controller is provided for dynamically calculating hydraulic fluid requirements at the hydraulic fluid output as work is performed. The hydraulic fluid requirements are primarily provided by the first hydraulic pump powered by the electric power source and supplemented, as directed by the controller, by the second hydraulic pump powered by the hydrocarbon burning power source.

### FIELD

There is described a hybrid power system that was developed for providing power to hydraulic pumps on drilling rigs, but has other potential applications.

### BACKGROUND

There is a need to reduce greenhouse gas emissions produced by drilling rigs. Drilling rigs generally have an electric power source that is considered to be a “green” emission free source of energy. This electric power source is capable of powering hydraulic pumps that provide hydraulic fluid to working systems in most, but not all situations.

### SUMMARY

There is provided a hybrid power source which includes an electric power source, a first hydraulic pump powered by the electric power source, a hydrocarbon burning power source, and a second hydraulic pump powered by the hydrocarbon burning power source. A hydraulic fluid output is fed by a combined output from the first hydraulic pump and the second hydraulic pump. A controller is provided for dynamically calculating hydraulic fluid requirements at the hydraulic fluid output as work is performed. The hydraulic fluid requirements are primarily provided by the first hydraulic pump powered by the electric power source and supplemented, as directed by the controller, by the second hydraulic pump powered by the hydrocarbon burning power source.

The hybrid power system, as described above, is capable of reducing greenhouse gas emissions, while also providing redundancy against a possible failure of the electric power source. It also extends the useful life of the hydrocarbon burning power source, which will not be needed and can be shut down for a large proportion of the time. The sensor input into the controller will vary with each application. For a lifting application, a weight of a load to be lifted and distance the load has travelled over time will be used. The controller must also know the horse power requirements for the first hydraulic pump and the second hydraulic pump, along with output flow rates from each pump.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic of a hybrid power system.

### DETAILED DESCRIPTION

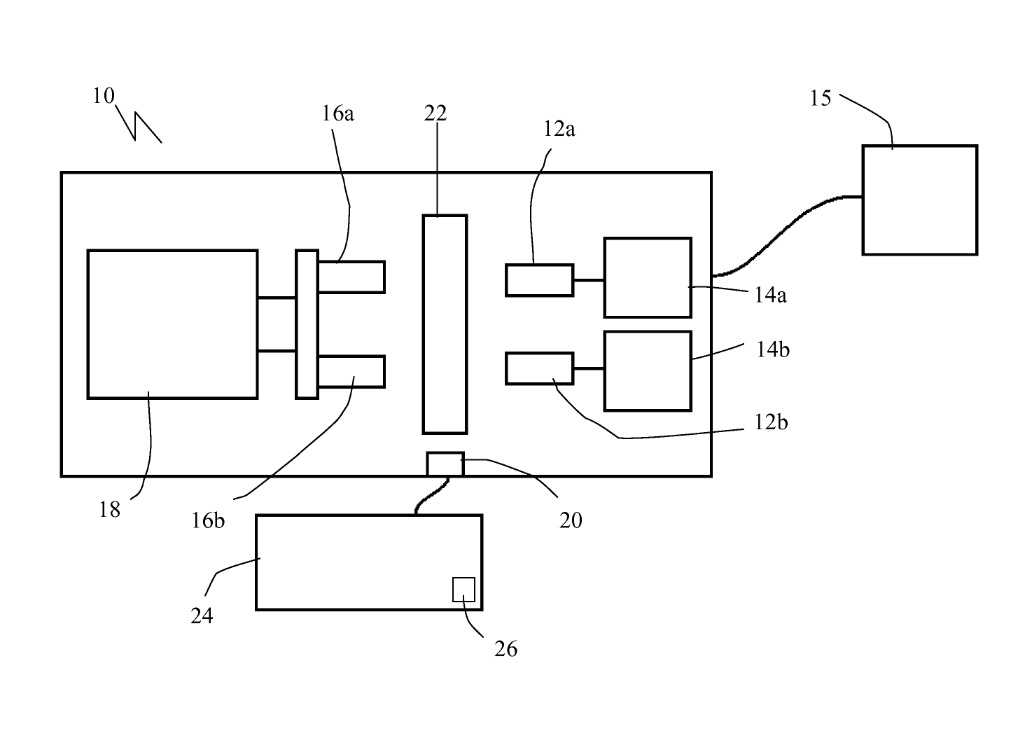

A hybrid power system generally identified by reference numeral 10, will now be described with reference to FIG. 1.

### Structure and Relationship of Parts:

Referring to FIG. 1, hybrid power system 10 uses primarily a first pair of hydraulic pumps 12a and 12b powered by a pair of 100 horsepower electric motors 14a and 14b. Electricity to power electric motors 14a and 14b is provided by an electric power supply 15. A second pair of hydraulic pumps 16a and 16b powered by a hydrocarbon burning power source 18, typically a 500 horsepower diesel engine, supplements power provided by first pair of hydraulic pumps 12a and 12b based upon hydraulic fluid requirements at hydraulic fluid output 20. Hydraulic fluid output 20 is fed by a combined output from both first pair of hydraulic pumps 12a and 12b and second pair of hydraulic pumps 16a and 16b. The extent to which second pair of hydraulic pumps 16a and 16b are utilized to supplement first pair of hydraulic pumps 12a and 12b is controlled by a programmable logic controller 22 for dynamically calculating hydraulic fluid requirements at hydraulic fluid output 20 as work is performed. Hydraulic fluid output 20 supplies hydraulic fluid to a hydraulic lift system 24. Sensor data, such as weight of a load being lifted and distance travelled by the load over a time interval, is provided to controller 22 from sensors 26 to regulate use of second pair of hydraulic pumps 16a and 16b.

### Operation:

Referring to FIG. 1, hybrid power system 10 begins performing work using first pair of hydraulic pumps 12a and 12b which are powered by electric motors 14a and 14b, respectively. Hydraulic fluid output 20 supplies hydraulic fluid to hydraulic lift system 24. Sensor data from sensors 26 attached to hydraulic lift system 24 is provided to controller 22 to regulate use of second pair of hydraulic pumps 16a and 16b. When required, second pair of hydraulic pumps 16a and 16b, which is powered by a hydrocarbon burning power source 18, supplements the power provided by first pair of hydraulic pumps 12a and 12b. This causes an increase in the amount of hydraulic fluid at hydraulic fluid output 20 and increases the work capabilities of hydraulic lift system 24.

### EXAMPLE 1

### Off Bottom Lift

This example deals with a lift of a drill string off bottom in an off shore drilling rig. If the weight of the drill string is 70,000 pounds and the target speed is to raise the drill string at a rate of 10-15 meters per minute calculations can be made as to a combined flow rate required from the first pair of hydraulic pumps 12a and 12b powered by the electric motors 14a and 14b and the second pair of hydraulic pumps 16a and 16b powered by the hydrocarbon burning power source 18. That combined flow rate can be converted into a combined horse power requirement to produce the combined flow rate. Assuming that a total horse power of 250 horse power is required to get the 70,000 pound drill string moving at the target rate of 10-15 meters per minute. The electric power source has a finite horse power limit. In that instance, the controller may determine that 115 horse power can be provided by the electric power source and that the remaining 135 horse power will have to be supplemented with the hydrocarbon burning power source. The contributions of the first pair of hydraulic pumps 12a and 12b and the second pair of hydraulic pumps 16a and 16b to the combined flow rate of hydraulic fluid will be governed according to the power contributions of the electric power source and the hydrocarbon burning power source.

### EXAMPLE 2

### Drill String in Motion

This example deals with a drill string in motion which is approaching surface. A drill string at rest has some initial inertia to overcome, as well as a column of water pressing down from above. When the drill string is in motion, it takes less power to keep it in motion and the weight decreases in a linear fashion at the drill string reaches surface at a rate of 6.6 pounds per foot raised. If the weight of the drill string has decreased to 20,000 pounds, 96 horse power is required to maintain the drill string in motion. As 96 horse power is within the capacity of the electric power source, the controller shuts down the hydrocarbon fuelled power source and has all hydraulic requirements provided by the first pair of hydraulic pumps 12a and 12b powered by the electric power source.

### Calculations:

In order to perform the calculations in Example 1 and Example 2, some sensor data is required. The depth of the drill string must be determined through the use of a depth encoder and its total weight at a given depth calculated. The speed that the drill string is travelling over a given time interval must also be determined The horse power requirements and the flow output of the first hydraulic pump must be known. The horse power requirements and the flow output of the second hydraulic pump must be known.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A hybrid power source, comprising:
an electric power source;
a first hydraulic pump powered by the electric power source;
a hydrocarbon burning power source;
a second hydraulic pump powered by the hydrocarbon burning power source;
a hydraulic fluid output fed by a combined output from the first hydraulic pump and the second hydraulic pump; and
a controller for dynamically calculating hydraulic fluid requirements at the hydraulic fluid output as work is performed, the hydraulic fluid requirements being primarily provided by the first hydraulic pump powered by the electric power source and supplemented as directed by the controller by the second hydraulic pump powered by the hydrocarbon burning power source.

2. The hybrid power source of claim 1, wherein the hydraulic fluid output is used to supply hydraulic fluid to a hydraulic lift system.

3. The hybrid power source of claim 2, wherein sensor data is provided to the controller, the sensor data including a weight of a load being lifted and a distance travelled by the load over a time interval.
